(19) United States
(12) Patent Application Publication
(10) Pub. No.: US 2009/0083118 A1
(43) Pub. Date: Mar. 26, 2009

(54) SEGMENTED MOTIVATION PROFILES

(75) Inventors: Jennifer Lynn Kallery, O'Fallon, MO (US); Richard M. Garlick, Des Plaines, IL (US); Paula R. Godar, Fenton, MO (US); Keith Chrzan, Chesterton, IN (US); Tammy L. Smith, Webster Groves, MO (US); Bob Moore, Wildwood, MO (US)

Correspondence Address: SENNIGER POWERS LLP, 100 NORTH BROADWAY, 17TH FLOOR, ST LOUIS, MO, 63102, US

(73) Assignee: MARITZ INC., Fenton, MO (US)

(21) Appl. No.: 11/859,508

(22) Filed: Sep. 21, 2007

(51) Int. Cl. G06Q 30/00; G06Q 10/00

(52) U.S. Cl. 705/10; 705/14

(57) ABSTRACT

A method of developing a motivation to motivate participants associated with a program-owner. The reward types of a motivation profile are defined and the participants' preferences are collected through a survey. The collected participants' preferences are modeled to determine segments of participants with similar reward preferences. An optimal motivation profile consisting of the participants' preferred reward types is generated from the modeled data and presented to the program owner in a detailed report. Additionally, a motivation profile simulator for simulating the participants' preference to a proposed motivation profile and a segmentation tool for displaying the characteristics of each segment is generated.

### BACKGROUND

Retention of employees is an important goal for successful companies. As part of a retention program, companies typically recognize and reward employees. Studies have shown that 79% of employees cite “lack of recognition” as a key factor for leaving their company. Furthermore, a poll conducted in 2004 found 25% of those who frequently receive a simple “thank you” from their manager are likely to leave their company, while 81% who never receive that thank you are likely to leave. And, of employees who indicate they are consistently recognized (1) 65% are very happy to spend their career with company; (2) 71% are “completely satisfied” with their jobs; (3) 50% would invest personal funds in company; and (4) only 14% indicated a willingness to leave their job.

However, it can be difficult to determine the recognition and reward preferences that are personally meaningful to individual employees. In the past, companies may use “gut feel” or a few group demographics as guideposts for recognition and reward decisions. However, in a poll of adult employees (18 or older, US, employed full time, not self-employed, gender split), no meaningful differences in recognition and reward preferences were tied to classification groupings to enable decision making by demographics (e.g., Age, Gender, Supervisor vs. Non-Supervisor, Sales vs. Non-Sales, Household income).

Furthermore, once a company decides on a recognition and reward program, it can be difficult to gage its effectiveness because of overlapping preferences of employees. In the past, decisions regarding recognition and reward programs have been made on an ad hoc basis with little participant insight and understanding of how these programs could be improved to provide the maximum motivation for the largest segment of employees.

### SUMMARY

Embodiments of the invention include a method of developing a motivation profile to motivate participants associated with a program-owner. In one embodiment, the invention includes a method of developing a motivation profile to motivate participants associated with a program-owner. The reward types of a motivation profile are defined and the participants' preferences are collected through a survey. The collected participants' preferences are modeled to determine segments of participants with similar reward preferences. An optimal motivation profile consisting of the participants' preferred reward types is generated from the modeled data and presented to the program owner in a detailed report. Additionally, a motivation profile simulator for simulating the participants' preference to a proposed motivation profile and a segmentation tool for displaying the characteristics of each segment is generated.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is flow diagram for a method of developing a motivation profile according to one embodiment of the invention.

FIG. 2 is a screen shot of a segmentation tool according to one embodiment of the invention.

FIG. 3 is a screen shot of a segmentation report according to one embodiment of the invention.

FIGS. 4A and 4B are screen shots of a motivation profile simulator according to one embodiment of the invention.

FIGS. 5A and 5B are screen shots of an optimal motivation profile according to embodiments of the invention.

FIG. 6 is a screen shot of a reward frequency report according to one embodiment of the invention.

Corresponding reference characters indicate corresponding parts throughout the drawings.

### DETAILED DESCRIPTION

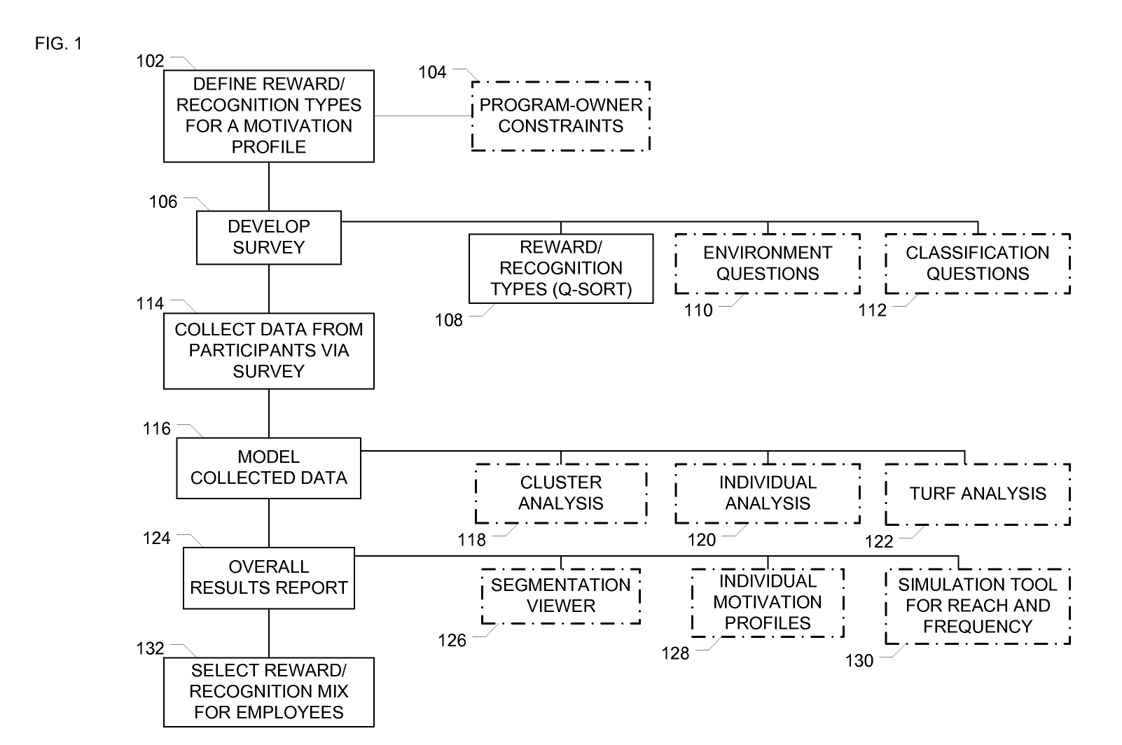

FIG. 1 illustrates a method of developing a motivation profile for a plurality of participants. The motivation profile specifies a reward preference of the plurality of participants. A program owner develops the motivation profile to motivate the participants by providing rewards and recognition when the participants attain an objective of the program owner. For example, a company (as a program owner) may wish to develop a motivation profile to motivate its employees (as participants) by providing a plaque (as the reward) as part of ceremony in front of the participant's peers (as the recognition) for achieving and/or exceeding a company objective (e.g., reducing costs). The program owner may include, but is not limited to one or more of the following: a company, consulting firm, an employer, an organization and a manufacturer. The participants may include, but are not limited to employees, salespersons, dealers, independent contractors, customers and distributors related to the program owner.

At 102, the program owner defines reward types. The reward types may include, but are not limited to include at least one of the following: verbal praise, written praise, formal praise in front of others, recognition from my peers, lunch or dinner with company management, lunch or dinner with my department, lunch or dinner with my family, cash bonus, gift cards, points awards that can be accumulated and used toward a catalog of merchandise, travel awards, status awards like trophies or plaques, days off, flexible scheduling, freedom to choose how to achieve own goals, opportunity to attend a conference or seminar, assignment to mentor other employees, choice of interesting projects to work on, challenging projects and opportunity to work with people outside of typical area.

In an embodiment, at 104, the program owner defines constraints to the reward types. The constraints are program owner limitations to the types of rewards available to motivate the participants. For example, the cost of the reward may be a constraint. In this case, the employer may wish to limit the value of merchandise or choose to rewards with minimal cash outlays, such as allowing an employee to choose a work-related project that is of particular interest to that employee.

At 106, a survey is defined to gather data related to the defined reward preferences of the plurality of participants. The survey is designed to identify the overall perception and use of rewards and recognition for the plurality of participants. In general, the survey is designed to identify which reward types are most meaningful and motivating to each participant.

In an embodiment, the survey includes defining Q-sort (sorting of most important to least important items) format questions to determine reward preference at 108, defining environment questions at 110 and classification questions at 112. A reward preferences component utilizes Q-sort techniques to format questions from a plurality of pre-determined reward types for participants. In an embodiment a Q-sort of an estimated 20 pre-determined reward types is conducted with the option for adding up to 5 more reward types. The format of the question may be asked as one question, or split between a small effort/impact situation and a large effort/impact situation. An exemplary survey template developed in accordance to aspects of the invention is shown in Appendix A.

Q-sort is a method of scaling responses in survey research. Two commonly used scales allow participants to spread their responses to a group of items to be rated in any way they like (e.g., they can mix their ratings any which way, including by giving all items low ratings and all items high ratings), and allow respondents identify a single top ranked item, a single second ranked item and so on all the way to a single lowest ranked item. Unlike these commonly used scales, Q-sort forces participants to rank the items (e.g., reward types) to conform to a quasi-normal distribution. That is, it requires only a very small number of items to receive the highest rating and the lowest rating. It requires larger, but still small, numbers of items to receive the next highest and next lowest rating. It forces to respondent to rate most items in a middle category, so that the resulting distribution of ratings follows the familiar bell-shaped normal curve. For example, for a Q-sort rating of 15 items, the distribution into 5 groups, lowest to highest might be: 1:3:7:3:1.

A reward use component classifies of receipt or use of the plurality of pre-determined reward and reorganization types. An overall engagement and environment component utilizes agreement ratings for a plurality of statements regarding engagement and recognition for the plurality of participants.

At 114, the program owner presents the defined survey to the plurality of participants to collect response data from the plurality of participants related to the presented survey. In one embodiment, the survey is provided to a subset of potential participants to collect participants' reward preferences. The survey may be offered to all participants, all potential participants, or a subset of the potential participants.

The survey may be conducted online, conducted through paper surveys, or conducted through any other known surveying techniques. In an embodiment, the online survey is emailed directly to the participants, either from a known email (i.e., program e-mailbox or from a recognizable client company representative) or having been proceeded by a notification email from a known email source. In instances where email addresses are not all available, options can be addressed through survey link placement on a company or program website (expecting lower response rates) or paper survey (incurring printing/postage/entry costs and a longer/more complex survey).

At 116, the collected data is modeled to identify one or more segments of participants. In an embodiment, the segments are identified as a function of the collected data. Each identified segment of participants includes participants associated with the subset of the reward types, such that each segment of participants has similar reward and recognition preferences. The subset of the reward types preferred by the segment defines the motivation profile of each segment of participants. Alternatively, the survey is presented to a subset of participants within an organization. The data is collected from the subset of participants within an organization, and the identified segments associate the reward and recognition preferences of all participants within the organization.

In Table 1, the exemplary results of list of identified segments from the survey are shown.

TABLE 1

| Segment | | They more often don''t care |
|---|---|---|
| Profile | They more often want: | about: |
| Award Seekers | Gift cards, points, travel awards, trophies | Conferences/seminars, mentoring, |
| (22%) | or plaques | choice of projects, challenging |
| | | projects, work outside their area |
| Nesters (20%) | Verbal praise, lunch/dinner with | Travel awards, conferences/ |
| | department, days off, flexible scheduling | seminars, trophies/plaques |
| Bottom Liners | Cash, gift cards, points, travel awards | Formal public praise, verbal praise, |
| (19%) | | written praise, recognition from |
| | | peers, trophies/plaques |
| Freedom | Choose how they achieve goals, | Gift cards, points, cash, |
| Yearners or | conferences/seminars, interesting | trophies/plaques |
| Freedom | projects, challenging project, flexible | |
| Seekers (17%) | scheduling | |
| Praise Cravers | Written praise, verbal praise, formal | Lunch/dinner with department, |
| (16%) | public praise, recognition from peers | days off, flexible scheduling |
| Upward | Lunch/dinner with management, | Cash, days off, written praise |
| Movers (8%) | trophies/plaques, working with people | |
| | outside their area, conferences/seminars, | |
| | mentoring others | |

In an embodiment, at 118, cluster analysis is conducted on the collected data identify the segments of participants; at 120, individual analysis of the collected data is used to identify the motivation profile of each participant; and, at 122, TURF (Total Unduplicated Reach and Frequency) analysis of the collected data is used to determine the reach frequency, and overlap between the identified segments.

Cluster analysis is a mathematical method for categorizing objects (e.g., participants) into segments where the members of a segments are more similar to one another than they are to members of other segments. In this case, the objects are the participants. And, the participants are segmented by their rated responses to each of the reward types. Cluster analysis involves repetition of one or more clustering algorithms (e.g., convergent K-means cluster analysis) to identify robust solutions plus analysis of various fit statistics (primarily the “silhouette number”) plus detailed investigation of the managerial usefulness of the motivation profile.

In an embodiment, at 124, an overall results report is generated as a function of the modeled data. The generated report specifies the reward and recognition preferences of the participants as a function of the identified segments and the collected data. In another embodiment, the report includes segment definitions, segment preferences and classification of differences between the identified segments. For example, the results may include total respondent agreement on engagement and recognition at the company, stated medium importance, medium usage/receipt, derived medium importance based on comparing usage/receipt to overall ratings such as engagement, the size and characteristics of segments differing in reward and recognition preferences via cluster analysis and providing individual motivational profiles based on reward and recognition preferences to managers to ensure use of meaningful reward and recognition types for the individual participant.

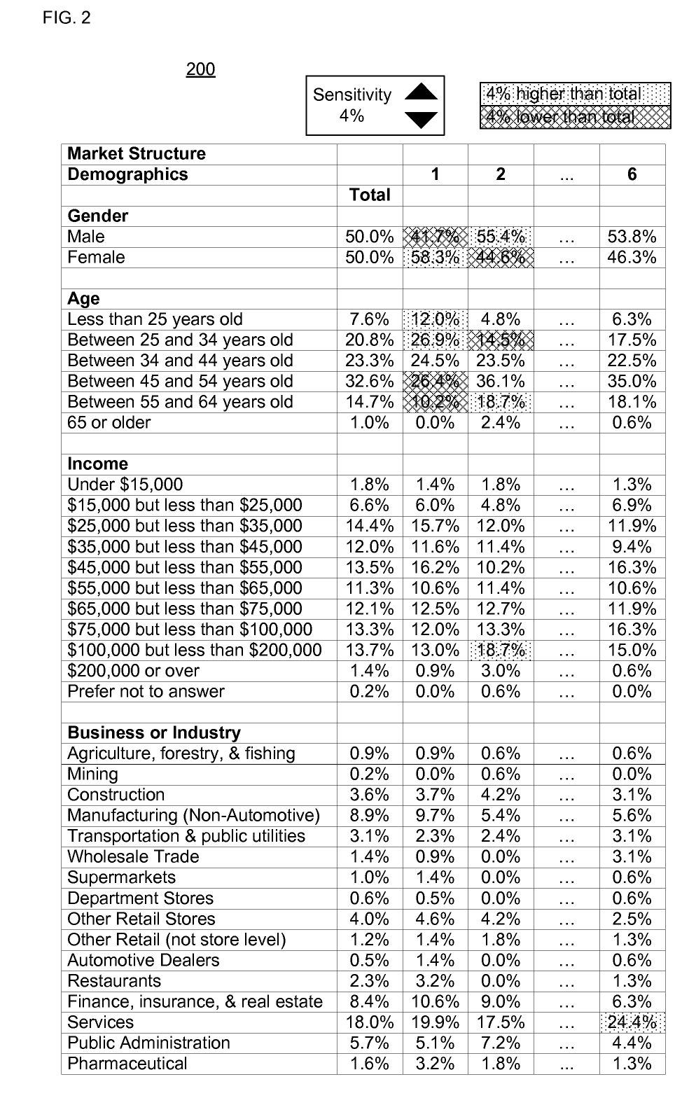

Alternatively, at 126, a segmentation viewer is generated as a function of the identified segments and the collected data. In FIG. 2, an embodiment of the segmentation viewer 200 is illustrated. The segmentation viewer includes a user interface for adjusting the sensitivity and displaying the result. The segmentation viewer 200 may be used by the program owner to determine common characteristic of particular segments. In FIG. 2, the sensitivity is set to 4%. For example, Segment 1 contains more than 4% more female participants (58.3%) than the total female participants (50%) while Segment 2 contains more than 4% more male participants (55.4) than total male participants (50%). The program owner can adjust the sensitivity and the display will update accordingly.

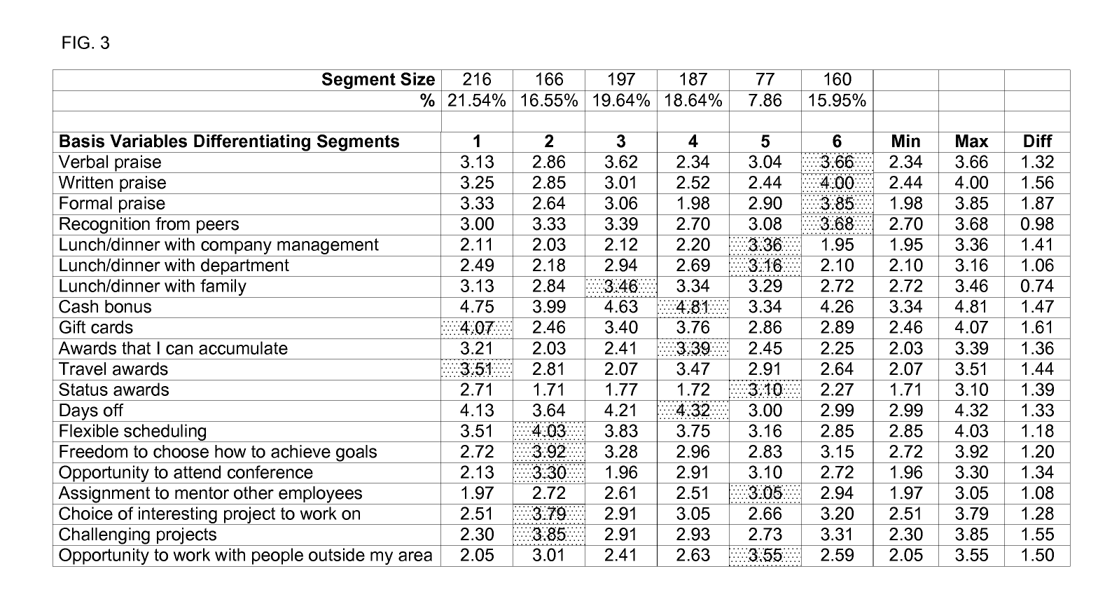

In an embodiment, a report displaying the segment sizes and bases is generated in addition to the segmentation viewer. An exemplary report is illustrated in FIG. 3. The highlighted cells indicate with segment most preferred a particular reward type. For example, Segment 3 prefers “lunch/dinner with family” more than the other segments while Segment 5 prefers “lunch/dinner with company management”, “lunch/dinner with department”, “status awards”, “assignment to mentor other employees”, and “opportunity to work with people outside my area” more than the other segments.

Referring again to FIG. 1, in another alternative, at 128, individual motivation profiles for each of the plurality of participants are generated as a function of the identified segments and the collected data. In this case, the reward and recognition preferences of each of the participants is identified as a function of the collected data. The identified reward and recognition preference of each participant defines the motivation profile for each participant. A manager of a particular participant may access the motivation profile of the particular participant to determine a meaningful and motivating reward and recognition for the particular participant.

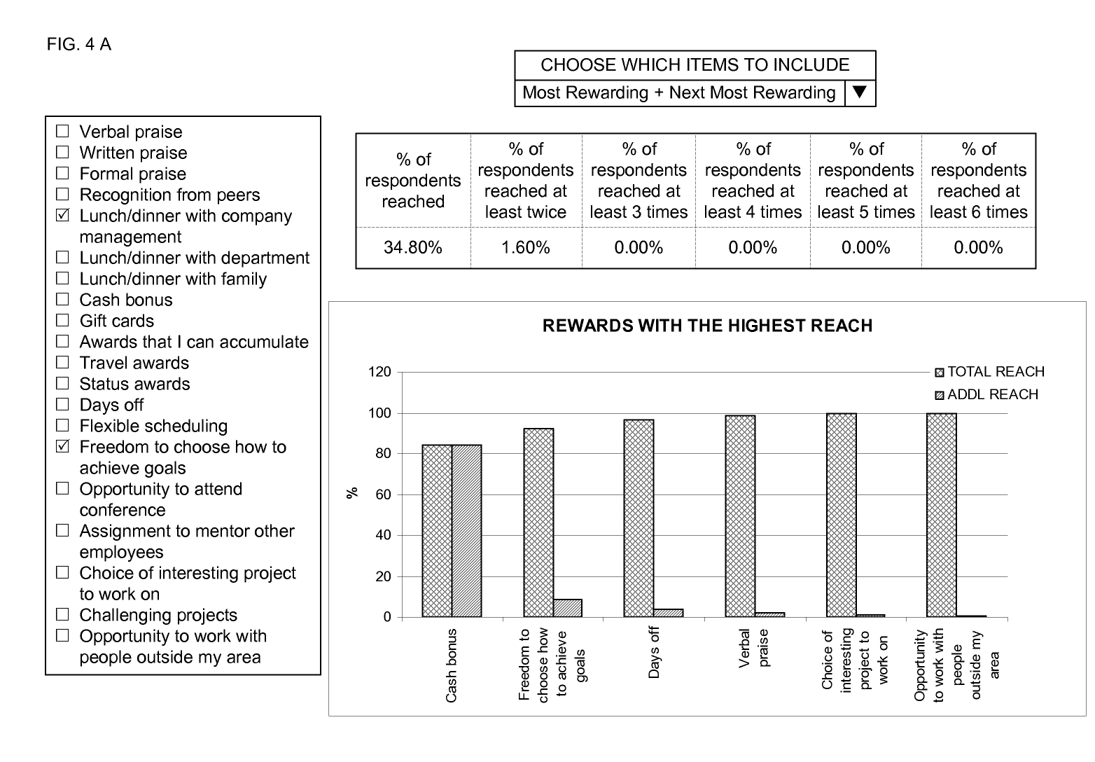

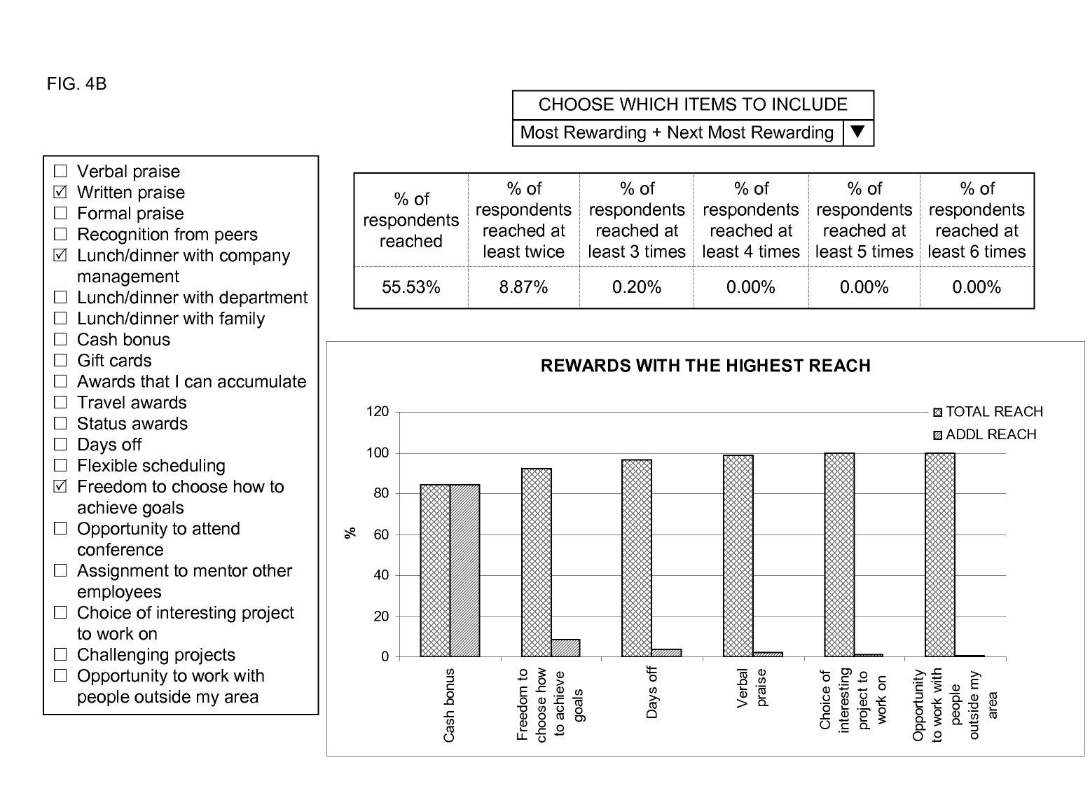

And, in a third alternative, at 130, a simulation tool is generated as a function of the modeled data. The simulator tool includes a user interface, such as the embodiment illustrated in FIGS. 4A, 4B. The simulator tool may be used for testing the reach, frequency and overlap of potential motivation profiles. For example, in FIG. 4A, the program owner has selected “lunch with company management” and “free to choose how “to achieve goals”. The display shows 34.8% of participants chose one of these two types of rewards as a first or second preference. Additionally, 1.60% of the participants chose these two types of rewards as a first and second preference. And, in FIG. 4B, the program owner selects “written praise” in addition to lunch with company management and free to choose who to achieve goals. The display indicates shows 55.53% of participants chose one of these three types of rewards as a first or second preference. Additionally, 8.87% of the participants chose these two of the three types of rewards and/or recognition as a first and second preference.

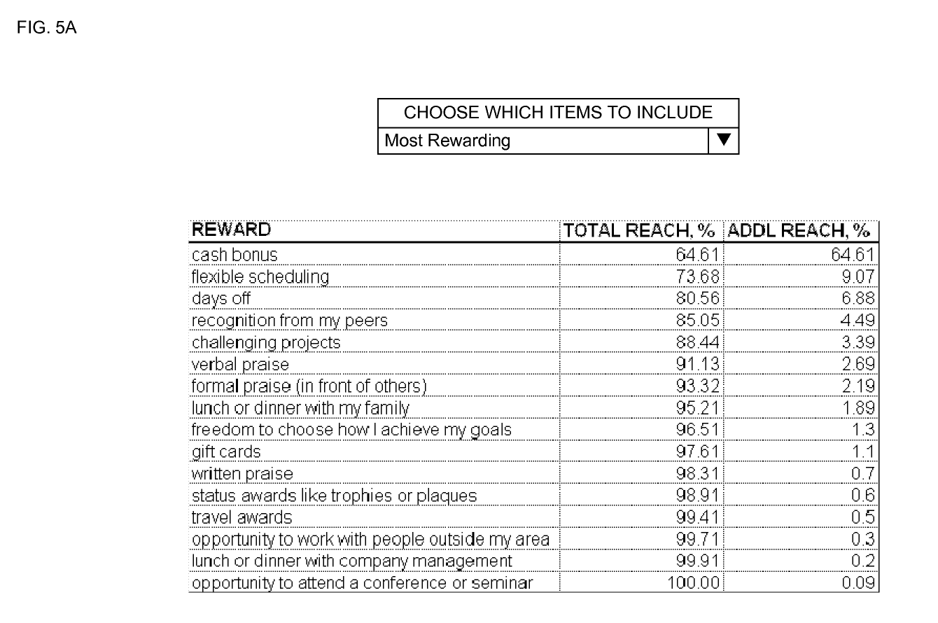

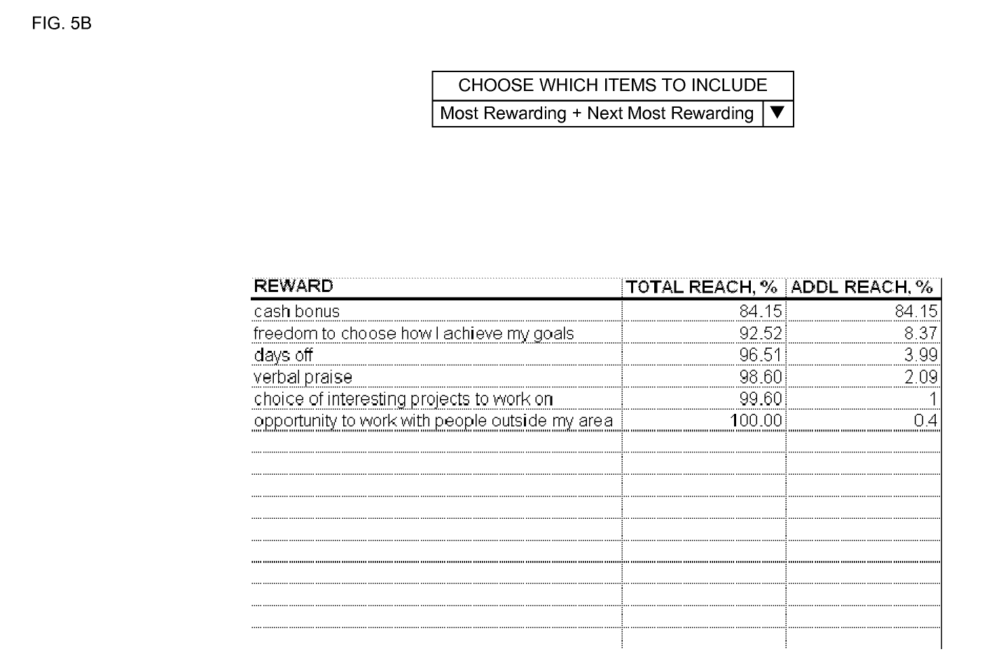

In an embodiment, as illustrated in FIG. 5A an optimal motivation profile may be provided. The motivation profile in 5A lists the reward, the total number of participants which prefer the reward, and the additional reach gained by adding the reward where 100% of the participants are most motivated by at least one of the rewards. For example, in FIG. 5A, the optimal motivation profile includes “cash bonus”, “flexible scheduling”, “days off”, “recognition from my peers”, “challenging projects”, “verbal praise”, “formal praise (in front of others)”, “lunch or dinner with my family”, “freedom to choose how I achieve my goals”, “gift cards”, “written praise”, “status awards like trophies or plaques”, “travel awards”, “opportunity to work with people outside my area”, “lunch or dinner with company management”, and “opportunity to attend a conference or seminar.” And, in FIG. 5B an optimal motivation profile lists the reward, the total number of participants which prefer the reward, and the additional reach gained by adding the reward where 100% of the participants found at least one of the rewards most rewarding or next most rewarding. For example, in FIG. 5B, the optimal motivation profile includes “cash bonus”, “freedom to choose how I achieve my goals”, “days off”, “verbal praise”, “choice of interesting projects to work on”, and “opportunity to work with people outside my area.”

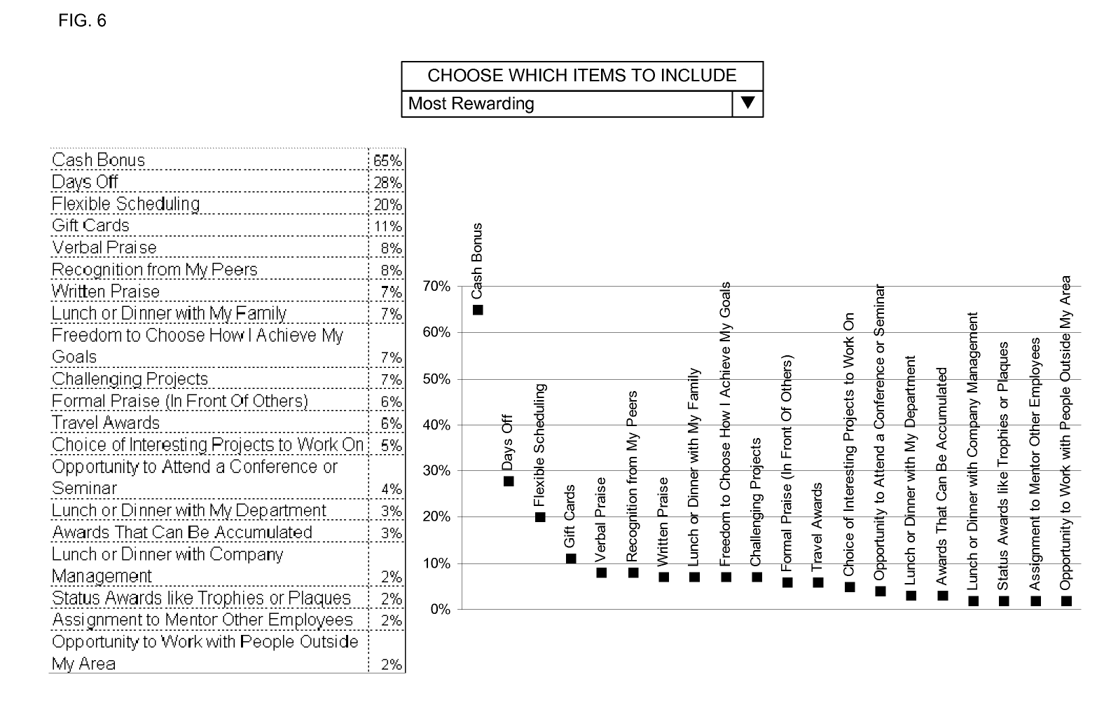

In another embodiment, as illustrated in FIG. 6, the frequency each award was chosen may be provided. For example, “cash bonus” was chosen most rewarding by 65% of the participants and “days off” was chosen most rewarding 28% of the time. In an alternative embodiment (not illustrated), the report indicates the percent of time the participants found a reward either most rewarding or next most rewarding.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a” “an” “the” and “said” are intended to mean that there are one or more of the elements. The terms of “comprising,” and “having” are intended to be inclusive and mean that there may be additional elements other than the listed elements.

As various changes could be made in the above constructions, products, and methods without departing from the scope of aspects of the invention, it is intended that all matter contained in the above description and shown in the accompanying drawings shall be interpreted as illustrative and not in a limiting sense.

### APPENDIX A

Below is a survey template according to aspects of the invention.

### Introduction

This survey is about your opinions of the reward and recognition options regarding your role at [CLIENT]. It should take approximately 10 minutes to complete. This survey will help inform the choices [CLIENT] makes about recognition offered to you. We appreciate your participation—Thank you.

### [SECTION 1] Overall

[Q] Are you a manager with direct reports?

ο Yes

ο No

[Q2 ] IF NOT ALSO DOING “MOTIVATION ENVIRONMENT” SURVEY (˜20 questions, all but 1 rating style), PULL AT LEAST 5 “OVL”/“MEANINGFUL”/“CONSISTENT”/“RIGHT” RATING QUESTIONS AND ADD HERE. HAVE QUESTIONS RE: THE OVERALL OBJECTIVES YOU'RE TRYING TO ACHIEVE WITH THE AWARD OFFERINGS.

### [SECTION 2] Personal Reward & Recognition Preferences

This section asks you to identify your reward & recognition preferences. Your responses to this section will be used to both (1) identify key recognition options needed at your overall company level, and (2) to also provide employee recognition profiles back to managers. These profiles will be used to ensure you are recognized in ways that are meaningful to you.

### Situation 1: “Small” Effort/Impact

### You Performed Above Expectations or Requirements on a Quick Project or Situation that Took Less than a Couple Hours of Your Time

[Q3A] In this situation, please indicate which of the following aspects would be the most rewarding to you and which would be the least rewarding to you:

| | Most Rewarding | Least Rewarding |
|---|---|---|
| | (mark 1) | (mark 1) |
| [ROTATE] | [CODE = “5”] | [CODE = “1”] |
| [PORTION OF LIST FROM | [symbol] | [symbol] |
| Q5, E.G., 10-15 ASPECTS] | | |
| . . . | [symbol] | [symbol] |

[ANY ASPECTS ABOVE DEFINITELY NOT TO BE CONSIDERED BY THE CLIENT SHOULD BE REMOVED. A LIST OF 20 OR FEWER IS RECOMMENDED FOR RESPONDENT EASE.]]Q3B] Of the remaining, which would be the most and least rewarding to you?

| | Most Rewarding | Least Rewarding |
|---|---|---|
| | (mark 2) | (mark 2) |
| | [CODE = “4”] | [CODE = “2”] |
| [LIST EXCLUDING THOSE | [symbol] | [symbol] |
| MARKED IN Q3A ABOVE] | | |

### [CODE ANY ITEMS NOT SELECTED AS “3”

### Situation 2: “Big” Effort/Impact

### You Performed Above Expectations or Requirements on a Long-Term Project or Objective that had Positive Impact Beyond Your Own Job

[Q4A] In this situation, please indicate which of the following aspects would be the most rewarding to you and which would be the least rewarding to you:

| | Most Rewarding | Least Rewarding |
|---|---|---|
| | (mark 1) | (mark 1) |
| [ROTATE] | [CODE = “5”] | [CODE = “1”] |
| [PORTION OF LIST FROM | [symbol] | [symbol] |
| Q5, E.G., 10-15 ASPECTS] | | |
| . . . | [symbol] | [symbol] |

### [ANY ASPECTS ABOVE DEFINITELY NOT TO BE CONSIDERED BY THE CLIENT SHOULD BE REMOVED. A LIST OF 20 OR FEWER IS RECOMMENDED FOR RESPONDENT EASE.]

[Q4B] Of the remaining, which would be the most and least rewarding to you?

| | Most Rewarding | Least Rewarding |
|---|---|---|
| | (mark 3) | (mark 3) |
| | [CODE = “4”] | [CODE = “2”] |
| [LIST EXCLUDING THOSE | [symbol] | [symbol] |
| MARKED IN Q4A ABOVE] | | |

### [CODE ANY ITEMS NOT SELECTED AS “3”]

### [SECTION 3] Receipt of Reward & Recognition

For the set of questions below, please consider your job responsibilities and performance at [CLIENT] within the past year.

[Q5] How often have you received each of the following types of rewards and recognition within the past year?

| | Not | | | | |
|---|---|---|---|---|---|
| | nearly | | About | | Much |
| | as often/ | | as often/ | | more |
| [ROTATE] [ACTUAL CLIENT LIST MAY | much as | | much as | | than |
| VARY] | expected 1 | 2′ | expected 3 | 4 | expected 5 |
| 1. verbal praise | [symbol] | [symbol] | [symbol] | [symbol] | [symbol] |
| 2. written praise | [symbol] | [symbol] | [symbol] | [symbol] | [symbol] |
| 3. formal praise (in front of others) | [symbol] | [symbol] | [symbol] | [symbol] | [symbol] |
| 4. recognition from my peers | [symbol] | [symbol] | [symbol] | [symbol] | [symbol] |
| 5. lunch or dinner with company management | [symbol] | [symbol] | [symbol] | [symbol] | [symbol] |
| 6. lunch or dinner with my department | [symbol] | [symbol] | [symbol] | [symbol] | [symbol] |
| 7. lunch or dinner with my family | [symbol] | [symbol] | [symbol] | [symbol] | [symbol] |
| 8. cash bonus | [symbol] | [symbol] | [symbol] | [symbol] | [symbol] |
| 9. gift cards | [symbol] | [symbol] | [symbol] | [symbol] | [symbol] |
| 10. awards that can be accumulated, such as | [symbol] | [symbol] | [symbol] | [symbol] | [symbol] |
| points to redeem for items in a catalog of | | | | | |
| merchandise or at select retail locations | | | | | |
| 11. travel awards | [symbol] | [symbol] | [symbol] | [symbol] | [symbol] |
| 12. status awards like trophies or plaques | [symbol] | [symbol] | [symbol] | [symbol] | [symbol] |
| 13. days [or time?] off | [symbol] | [symbol] | [symbol] | [symbol] | [symbol] |
| 14. flexible scheduling | [symbol] | [symbol] | [symbol] | [symbol] | [symbol] |
| 15. freedom to choose how I achieve my goals | [symbol] | [symbol] | [symbol] | [symbol] | [symbol] |
| 16. opportunity to attend a conference or | [symbol] | [symbol] | [symbol] | [symbol] | [symbol] |
| seminar | | | | | |
| 17. assignment to mentor other employees | [symbol] | [symbol] | [symbol] | [symbol] | [symbol] |
| 18. choice of interesting projects to work on | [symbol] | [symbol] | [symbol] | [symbol] | [symbol] |
| 19. challenging projects | [symbol] | [symbol] | [symbol] | [symbol] | [symbol] |
| 20. opportunity to work with people outside my | [symbol] | [symbol] | [symbol] | [symbol] | [symbol] |
| area | | | | | |
| 21. [OPTIONAL ADD:] | [symbol] | [symbol] | [symbol] | [symbol] | [symbol] |
| 22. [OPTIONAL ADD:] | [symbol] | [symbol] | [symbol] | [symbol] | [symbol] |
| 23. [OPTIONAL ADD:] | [symbol] | [symbol] | [symbol] | [symbol] | [symbol] |
| 24. [OPTIONAL ADD:] | [symbol] | [symbol] | [symbol] | [symbol] | [symbol] |
| 25. [OPTIONAL ADD:] | [symbol] | [symbol] | [symbol] | [symbol] | [symbol] |

### Understanding Differing Needs

[ADD 3-5 CLASSIFICATION QUESTIONS IF NOT AVAILABLE IN THE RESPONDENT FILE]

What is claimed is:

1. A method of developing a plurality of motivation profiles for a plurality of participants, said motivation profile specifying a reward and recognition preference of the plurality of participants, said method comprising:
defining reward types;
defining a survey to gather data related to the defined reward types of the plurality of participants;
presenting the defined survey to the plurality of participants;
collecting response data from the plurality of participants related to the presented survey;
identifying one or more segments of participants as a function of the collected data wherein each segment of participants are participants associated with the a subset of the reward types, such that each segment of participants have similar reward preferences whereby the subset of the reward type defines the motivation profile of each segment of participants; and
selecting a defined reward type based on the identified segments.

2. The method of claim 1, further comprising:
analyzing the response data of the identified segments to determine one or more of the following: the reach of the segments, frequency of the segments, and overlap between segments.

3. The method of claim 2, wherein TURF (Total Unduplicated Reach & Frequency) analysis is conducted on the collected response data to analyze the response data.

4. The method of claim 1, wherein an optimal motivation profile is associated with the reward type of the identified segment of the participants with the greatest number of participants.

5. The method of claim 1, wherein an optimal motivation profile is associated with the reward types of a selected plurality of identified segments such that all participants are associated with at least one of the selected plurality of identified segments and the selected plurality of the identified segments have a minimum amount of overlap between the selected plurality of the identified segments.

6. The method of claim 1, said method further comprising:
identifying the reward types of each of the participants as a function of the collected data whereby the identified reward types of each participant defines the motivation profile for each participants;
accessing by a manager of a particular participant the motivation profile of said particular participant, said manager accessing the motivation profile to determine the a meaningful and motivating reward for said particular participant.

7. The method of claim 1, wherein the survey is presented to a subset of participants within an organization, the data is collected from said subset of participants within an organization, and the identified segments associate the reward type preferences of all participants within the organization.

8. The method of claim 1, wherein cluster analysis is conducted on the collected data to identify the one or more segments.

9. The method of claim 1, said method further comprising:
generating a report specifying the reward type preferences as a function of the identified segments and the collected data.

10. The method of claim 9, wherein the report includes segment definitions, segment preferences and classification of differences between the identified segments.

11. The method of claim 1, said method further comprising:
generating a simulator tool based the identified segments for testing the reach, frequency and overlap of potential motivation profiles.

12. The method of claim 1, said method further comprising:
determining an optimal motivation profile to motivate the largest number of the plurality of participants as a function of the collected data and the identified segments.

13. The method of claim 1, wherein the survey is designed to identify the overall perception and use of rewards and recognition for the plurality of participants.

14. The method of claim 1, wherein the survey is designed to identify which reward types are most meaningful and motivating to each participant.

15. The method of claim 14, wherein the reward types include at least one of the following: verbal praise, written praise, formal praise in front of others, recognition from my peers, lunch or dinner with company management, lunch or dinner with my department, lunch or dinner with my family, cash bonus, gift cards, points awards that can be accumulated and used toward a catalog of merchandise, travel awards, status awards like trophies or plaques, days off, flexible scheduling, freedom to choose how to achieve own goals, opportunity to attend a conference or seminar, assignment to mentor other employees, choice of interesting projects to work on, challenging projects and opportunity to work with people outside of typical area.

16. The method of claim 1, wherein the survey includes at least one of the following components:
reward preferences component utilizing Q-sort techniques of a plurality of pre-determined types for rewarding and recognizing participants;
reward use component utilizing the classification of receipt or use of the plurality of pre-determined types; and
overall engagement and environment component utilizing agreement ratings using a plurality of statements regarding engagement and recognition for the plurality of participants.

17. The method of claim 1, wherein the survey is presented online.

18. The method of claim 1, wherein the plurality of participants include at least one of the following: to employees, salespersons, dealers, independent contractors, customers and distributors.
